(19) United States
(12) Patent Application Publication
(10) Pub. No.: US 2020/0242655 A1
(43) Pub. Date: Jul. 30, 2020

(54) CONFIGURABLE COMPLIANCE-BASED REWARDS FOR VETERINARIAN CLINICS

(71) Applicant: VETLOCITY, LLC, Atlanta, GA (US)

(72) Inventor: Douglas H. Brown, Atlanta, GA (US)

(73) Assignee: VETLOCITY, LLC, Atlanta, GA (US)

(21) Appl. No.: 16/260,051

(22) Filed: Jan. 28, 2019

(51) Int. Cl. G06Q 30/02; G06Q 30/00; G06Q 50/10

(52) U.S. Cl. CPC G06Q 30/0236; G06Q 50/10; G06Q 30/018

(57) ABSTRACT

Systems and methods are provided for configurable compliance-based rewards for veterinarian clinics including providing, through a compliance administration wizard of an application, a set of criteria for pet-owner compliance for a veterinarian clinic; receiving, through the compliance administration wizard of the application, the set of criteria and associated attributes for pet-owner compliance for the veterinarian clinic; and generating, in dependence upon the criteria and the associated attributes, a configurable compliance schedule for providing rewards to the pet owner from the veterinarian clinic; monitoring, by a compliance-based rewards server, pet-owner activity; identifying, by the compliance-based rewards server, one or more rewards based on the pet-owner activity and the configurable compliance schedule; and presenting, to the pet owner through a GUI of a compliance-based rewards mobile application executing on a mobile device, one or more compliance-based rewards.

### BACKGROUND

Veterinary visits increase and decrease periodically based on many factors. Veterinary visits are currently decreasing. Veterinarians attribute infrequent visits and lack of compliance to treatment protocols to an increase in poor pet health and more expensive pet treatment. The pet owners who visit infrequently and fail to comply with treatment protocol have indicated that they would make more frequent visits and comply with protocol if they were confident that it could improve health and prevent expensive treatments.

### BRIEF DESCRIPTION OF THE DRAWINGS

Many aspects of the present disclosure will be better understood with reference to the accompanying drawings. The components in the drawings are not necessarily to scale, with emphasis instead being placed upon clearly illustrating the principles of the disclosure. Moreover, in the drawings, like reference numerals designate corresponding parts throughout the several views. Other technical advantages may become readily apparent to one of ordinary skill in the art after review of the following figures and description.

FIG. 1 sets forth a system diagram illustrating a system for customizable compliance-based rewards for veterinarian clinics according to example embodiments of the present invention.

FIG. 2 sets forth a system diagram of additional aspects illustrating customizable compliance-based rewards for veterinarian clinics according to embodiments of the present invention.

FIG. 3 sets forth a line drawing of an example compliance administration wizard according to embodiments of the present invention.

FIG. 4 sets forth a line drawing illustrating an example compliance-based points mobile application executing on a mobile device.

FIG. 5 sets forth another line drawing illustrating an example compliance-based points mobile application executing on a mobile device.

FIG. 6 sets forth another line drawing illustrating an example compliance-based points mobile application executing on a mobile device.

FIG. 7 sets forth another line drawing illustrating an example compliance-based points mobile application executing on a mobile device.

FIG. 8 sets forth another line drawing illustrating an example compliance-based points mobile application executing on a mobile device.

FIG. 9 sets forth another line drawing illustrating an example compliance-based points mobile application executing on a mobile device.

FIG. 10 sets forth a data flow diagram illustrating an example method for customizable compliance-based rewards for veterinarian clinics according to embodiments of the present invention.

### DETAILED DESCRIPTION

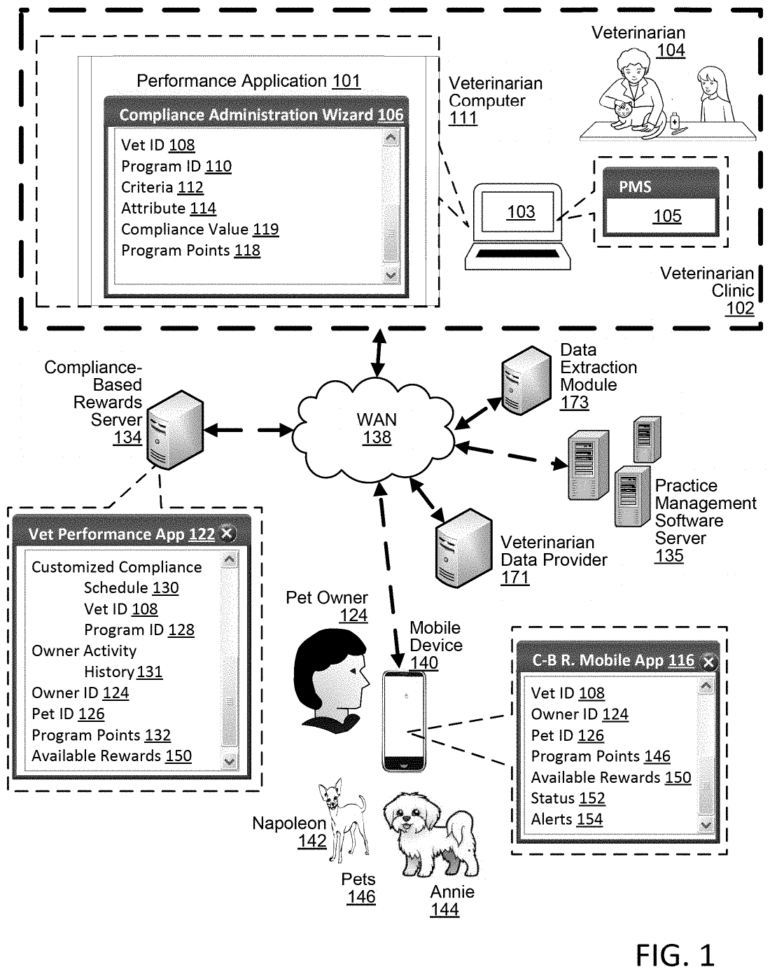

Example embodiments of the present invention are described with reference to the accompanying drawings, beginning with FIG. 1. FIG. 1 sets forth a system diagram illustrating a system for configurable compliance-based rewards for veterinarian clinics (102) according to example embodiments of the present invention. Configurable compliance-based rewards are typically implemented as discounts, gifts, coupons, or other benefits that will occur to those of skill in the art. Such compliance-based rewards are given by a veterinarian clinic to a pet owner based upon that pet owner following a treatment protocol dictated by the veterinarian clinic. These compliance-based rewards are configurable in the sense that each veterinarian clinic may dictate different protocols and provide different rewards to the pet owner for properly following the protocols. Furthermore, such compliance-based rewards are also customizable in the sense that protocols, activities, rewards, benefits and so may be unique to a particular veterinarian clinic.

Compliance represents a measure of a pet owner's fulfillment of activities dictated by a veterinarian clinic for the health and well-being of a pet. Often such activities are part of an overall protocol established for the pet by the veterinarian clinic. Compliance is used to asses a pet owner's fulfillment of the activities dictated by the veterinarian clinic and to provide rewards accordingly. Such rewards incentivize a pet owner's compliance and promote the health and well-being of the pet.

The system of FIG. 1 includes a compliance-based rewards server (134) coupled for data communications with a performance application (101) for a veterinarian clinic (102), a compliance-based points mobile application (116) executing on a mobile device (140), veterinarian data provider (171), a data extraction module (173), and a practice management software server (135) associated with the veterinarian clinic (102) each described in more detail below. In the example of FIG. 1, the compliance-based rewards server (134) is coupled for data communications with the compliance-based points mobile application (116) executing on a mobile device (140), the veterinarian data provider (171), the data extraction module (173), and the practice management software server (135) through a wide area network ('WAN'). The data communications depicted in the example of FIG. 1 is for explanation and not for limitation. In fact, any number of data communications infrastructures may be used according to embodiments of the present invention and often more than one protocol and infrastructure may be used. For example, networks that support configurable compliance-based rewards for veterinarian clinics also include Wi-Fi networks, local area networks, cellular networks, and many others as will occur to those of skill in the art.

The compliance-based rewards server (134) of FIG. 1 is a module of automated computing machinery that supports configurable compliance-based rewards for veterinarian clinics as described in more detail below. Automated computing machinery as that term is used in this specification means a module, segment, or portion of code or other automated computing logic, hardware, software, firmware, and others, as well as any combination of the aforementioned, as will occur to those of skill in the art—both local and remote. Automated computing machinery is often implemented as executable instructions, physical units, or other computing logic for implementing specified logical functions as will occur to those of skill in the art.

The performance application (101) for the veterinarian clinic (102) of FIG. 1 is a module of automated computing machinery that provides client-side interaction with a user or veterinarian (104) to establish one or more criteria for configurable compliance-based rewards according to embodiments of the present invention. The performance application (101) of FIG. 1 provides a compliance administration wizard (106) through a graphical user interface (‘GUI’) displayed on the display (103) of a veterinarian computer (111) for the veterinarian clinic (102). Such a compliance administration wizard (106) facilitates the presentation and acceptance of various criteria and other information used to establish particular compliance-based rewards for a pet owner for a particular veterinarian clinic.

The performance application (101) for the veterinarian clinic (102) of FIG. 1 is depicted as a server-side implementation that supports the compliance-based rewards server (134). This is for explanation and not for limitation. In fact, in many web-based embodiments, a compliance administration wizard may be made available to a veterinarian with little or no client-side infrastructure as will occur to those of skill in the art.

The example practice management software server (135) of FIG. 1 is automated computing machinery that provides practice management software and support for the veterinarian clinic (102). Such practice management software administers many aspects of the clinic's practice including scheduled appointments, diagnostic results, pet owner information, pet health history, prescriptions, and significantly more information as will occur to those of skill in the art. Examples of practice management software currently available include Advantage, AVImark, Cornerstone, DVMax, eVetPractice, HippoManager, Intro ity, intravet, and other similar software. The examples of practice management software are just that—examples. Many other practice management software products exist and regardless of design or infrastructure all such practice management software may be useful in various embodiments of the present invention.

In the example of FIG. 1, the veterinarian clinic (102) periodically provides information such as scheduled appointments, diagnostic results, pet owner information, pet health history, prescriptions, and significantly more information regarding its practice and animal patients to the practice management software server (135) through a PMS software application (105). In the example of FIG. 1, the PMS software application (105) is depicted as executing on the veterinarian computer (111) and provides a client-side interface to receive and transmit this information to the practice management software server (135).

The example of FIG. 1 includes a veterinarian data provider (171) and a data extraction module (173). The veterinarian data provider (171) of FIG. 1 is implemented as a module of automated computing machinery that periodically receives information regarding many individual veterinarian clinics from the practice management servers of those clinics and provides that information to the compliance-based rewards server (134). Such veterinarian data providers (171) facilitate the ability for a single compliance-based rewards system to operate with many disparate practice management software platforms.

Various veterinarian practices use various practice management software systems and as such the data maintained in those practice management software systems often requires translation to be usefully implemented by the compliance-based rewards server (134). The example of FIG. 1 therefore includes a data extraction module (173). The example data extraction module provides cloud-based data extraction including extract, transform, and load (‘ETL’) functions. ETL functions are three database functions that are combined into a single tool to pull data from one database and place it into another database. Extract is the process of reading data from a database. The data is collected, often from multiple and different types of sources. Transform is the process of converting the extracted data from its previous form into the form it needs to be in so that it can be placed into another database. Transformation occurs by using rules or lookup tables or by combining the data with other data. Load is the process of writing the data into the target database.

Information regarding various veterinarian clinics may be exposed to the compliance-based rewards server (134) through an application programing interface (‘API’) and such information be useful in administering configurable compliance-based rewards according to embodiments of the present invention as described in more detail below.

In the example of FIG. 1, the compliance-based points mobile application (116) is a module of automated computing machinery executing on a mobile device (140) of the pet owner (124). The compliance-based points mobile application (116) communicates with the compliance-based rewards server (134) to receive rewards, alerts, product and service offerings, and other information regarding the pet owner's pets (146)—in this example, Napoleon (142) the chihuahua and Annie (144) a mixed breed favorite of the pet owner's office—and presents that information in a useful and informative way to the pet owner (124).

The example compliance-based rewards server (134) of FIG. 1 is configured to receive a selection of one or more criteria (112) for which compliance-based rewards may be granted to a pet owner (124) by the veterinarian clinic (102) and one or more attributes (114) defining those compliance-based rewards for that criteria. In the example of FIG. 1, the compliance-based rewards server (134) receives such criteria and other information from a veterinarian clinic's performance application (101). To facilitate the selection of the one or more criteria (112) for which compliance-based rewards may be granted, the performance application includes a compliance administration wizard (106) that provides a graphical user interface (GUI') displaying to and accepting from a user (104) in the veterinarian clinic (102) a selection of one or more criteria (112) for which compliance-based rewards may be granted to a pet owner (124) and one or more attributes (114) defining those compliance-based rewards for that criteria. Such a user (104) may be a veterinarian, an employee, or any other user that will occur to those of skill in the art.

In the example of FIG. 1, the compliance administration wizard (106) receives a vet ID (106) identifying the veterinarian (104), the veterinarian clinic, or other user; a program ID (110) identifying a particular protocol of criteria, attributes, and other information; criteria (112) specific to the protocol; attributes (114) associated with those criteria (112); compliance values (119) to be associated with the program (110) and program points (118) associated with various aspects of complying with protocol of the program (110). The individual elements received from the compliance administration wizard in the example of FIG. 1 are for explanation and not for limitation. Compliance administration wizards according to example embodiments of the present invention may facilitate the reception of many other aspects of a veterinary practice as will occur to those of skill in the art.

Criteria (112) for which compliance-based rewards may be granted to a pet owner are one or more categories or generalized portions of a protocol for the veterinarian clinic. Examples of such criteria according to embodiments of the present invention include wellness exams, flea and tick prevention, heartworm prevention, vaccines, dental, bloodwork, and so on. These example criteria are presented for explanation and not for limitation. In fact, many other and different criteria may be useful in various embodiments of the present invention as will occur to those of skill in the art.

An attribute (114) is a value or set of values defining the performance requirements of the pet owner for one or more particular criteria (112). Attributes maybe single or multidimensional. For example, in the criteria of wellness. A defined attribute may be a particular number of wellness exams required per year according to a protocol defined by the veterinarian clinic and also that attribute may include the requirement that those wellness programs should occur at certain intervals. Rewards points may be assigned for the pet owner in complying with some or all of aspects of such an attribute of such criteria.

As just mentioned above, attributes may be multidimensional. The same can be said for criteria as well. That is, there is a many-to-many relationship between attributes and criteria that allow for great flexibility in defining protocols and rewards and points supporting those rewards to pet owners from veterinarian clinics as will occur to those of skill in the art.

The example compliance-based rewards server (134) of FIG. 1 is configured to generate, in dependence upon the criteria (112) and the associated attributes (114), a customized compliance schedule (130) for providing rewards (150) to the pet owner (124) from the veterinarian clinic (102). A customized compliance schedule (130) according to embodiments of the present invention is an implementation of a rewards program for a veterinarian clinic, for a pet owner, and in some cases for a particular period of time. Such a schedule defines points assigned to individual acts of pet owner that are in compliance, the number of points required to receive particular rewards, the particular rewards themselves, or other gifts or benefits that are given in dependence upon compliant owner activity as defined by the veterinarian clinic. In the example of FIG. 1, the customized compliance schedule (130) is associated with a particular vet ID (108) and program ID (110) for defining a protocol for compliance-based rewards for a particular clinic according to embodiments of the present invention.

To generate such a configurable compliance schedule (130), the compliance-based rewards server (134) receives the criteria and attributes for those criteria from the veterinarian clinic and applies a multidimensional algorithm using those criteria and attributes. Such an algorithm may include multipliers depending on not only compliance but also purchase behaviors and other pet owner activity. Algorithms may also be weighted in that they may favor one or more criterion, such as heartworm prevention, more than another criterion, such as dental treatments, in the assignment of points for rewards or rewards themselves. Similarly, such an algorithm may favor successive compliance in a criterion, such as heartworm prevention, such that successive compliance in a particular criterion favors more rewards. Furthermore, an algorithm may include a threshold of compliance that defines a status (such as silver, gold, platinum and so on) that may further favor rewards. As will occur to those of skill in the art, the multidimensional quality of criteria and attributes and the ability to favor any single one of them for rewards provides great flexibility to a veterinarian clinic in the generation of a rewards program according to embodiments of the present invention.

The example compliance-based rewards server (134) of FIG. 1 is also configured to monitor pet-owner activity (131) and identify one or more rewards (150) based on the pet-owner activity (131) and the configurable compliance schedule (130). In the example of FIG. 1, rewards may be identified in dependence upon program points calculated based on pet owner compliance and activity. Once identified, the example compliance-based rewards server (134) is configured to transmit the one or more rewards to the compliance-based rewards mobile application (116) executing on a mobile device (140) for presentation to the pet owner (124).

To monitor pet-owner activity (131), the example compliance-based rewards server (134) of FIG. 1 is configured to monitor pet-owner activity (131) by obtaining information regarding one or more veterinarian clinics from the veterinarian data provider (171). Obtaining information regarding one or more veterinarian clinics from the veterinarian data provider (171) may be carried out by invoking an application programming interface (‘API’) exposed by the practice management software server (135) to receive information regarding the veterinarian clinic's practice.

In the example of FIG. 1, the application (122) of the compliance-based rewards serer (134) receives and maintains owner activity (131) for an owner identified with an owner ID (124), having one or more pets identified with pet IDs (126), and associated with a particular configurable compliance schedule (130) for a program of a particular veterinarian clinic, veterinarian or other user.

The compliance-based rewards server (134) of FIG. 1 is configured to identify one or more rewards (150) based on the pet-owner activity (131) and the configurable compliance schedule (130) by assigning points for the pet-owner for one or more individual acts included in the pet-owner activity (131). Such individual acts may be rewarded differently as mentioned above. For example, a second wellness visit may be more heavily favored than the first wellness visit. Similarly, the purchase of a year supply of heartworm medication may be more heavily favored than a month supply.

The compliance-based rewards server (134) of FIG. 1 is configured to maintain a total number of points (132) for a pet owner (124) and compare the total number of points (132) with point values for available rewards (150). For example, such a comparison may identify that 1000 program points entitle the pet owner (124) to receive a free bath for one of the pets (146) at the veterinarian clinic. In some embodiments of the present invention, the clinic itself defines the rewards available and the points needed to earn those available rewards.

Rewards according to embodiments of the present invention include discounts, gifts, coupons, or other benefit that will occur to those of skill in the art given by a veterinarian clinic to a pet owner based upon that pet owner following a protocol dictated by the veterinarian clinic. Examples of such rewards include coupons for pet related products, discounts on pet boarding, a free bath for a pet, discounts in visit costs, free gifts and many other as will occur to those of skill in the art. Such rewards may be implemented as a digital and redeemable reward through the compliance-based rewards mobile application (116) as will occur to those of skill in the art. The rewards can also be redeemed through an online portal where a veterinarian or qualified employee can manually redeem the reward on the pet owner's behalf.

The compliance-based rewards server (134) of FIG. 1 is further configured to assign a status to the pet owner in dependence upon the total number of points for the pet owner. A status is a generalized category for the pet owner (124) entitling that pet owner to some defined rewards, benefits, coupons and so on. Simple example statuses include silver, gold, and platinum. A pet owner with the silver status may be entitled to some benefits and a pet owner with the gold status or the platinum status will be entitled to more benefits. Such status assignments are often made periodically in dependence upon the total number of program points earned by the pet owner based upon activity that is in compliance.

The compliance-based rewards server (134) of FIG. 1 is configured to provide to the pet owner one or more alerts through the compliance-based rewards mobile application (116). Alerts according to the example of FIG. 1, include notifications to the pet owner signifying a particular event. Examples of alerts include notification that a pet owner has achieved a certain status, notification to a pet owner that the pet owner is entitled to one or more rewards, and so on as will occur to those of skill in the art. Alerts may also be compliance-driven such as notifications of a scheduled wellness exam for a pet, a notification that prescription for a pet is ready at the clinic, and others as will occur to those of skill in the art.

In the example of FIG. 1, such an alert is transmitted to compliance-based mobile application (116) executing on the mobile device (140) of the pet owner (124) and presented by the application to the pet owner. In the example of FIG. 1, the compliance-based mobile application (116) maintains an associated veterinarian clinic identified by the vet ID (108) and associated with the pet owner (124). The example compliance-based mobile application (116) also maintains a pet ID (126) identifying one or more pets (146, 142, 144). The example compliance-based mobile application (116) also maintains and presents a current number of points (146) earned by the pet owner for compliance, available rewards (150) earned by the pet owner, a current status (152) of the pet owner and provides a number of alerts (154) for the pet owner.

In the example of FIG. 1, the compliance-based rewards server is configured to provide to the pet owner one or more products or services through the compliance-based rewards mobile application. Such products or services may include refills for prescriptions, scheduling to the pet owner, toys for the pet, food for the pet and many others as will occur to those of skill in the art. Such product or service offerings may be provided in conjunction or through an alert provided to the pet owner through the compliance-based rewards mobile application.

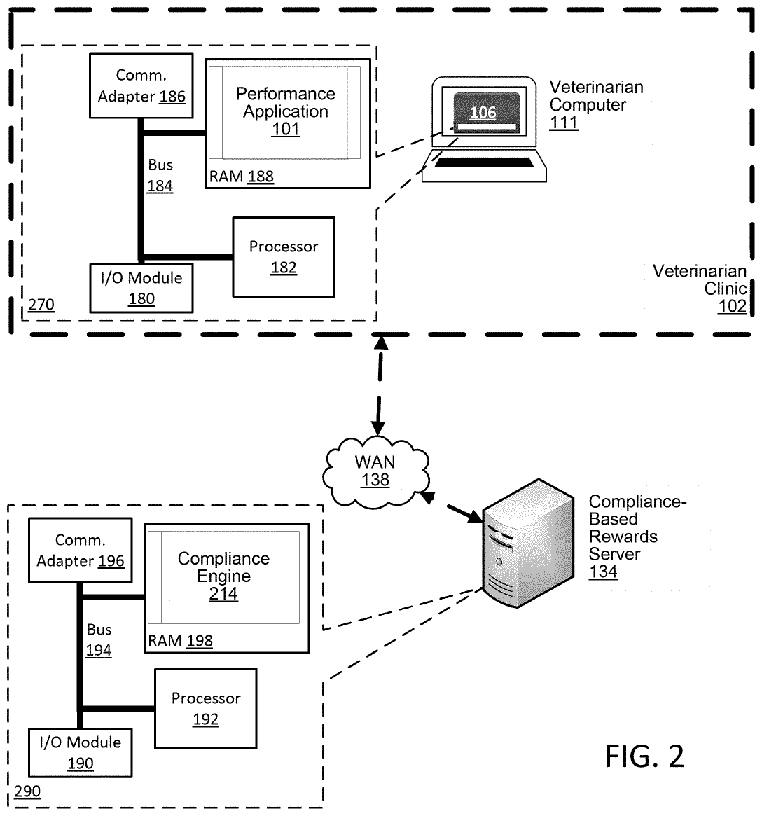

For further explanation, FIG. 2 sets forth a system diagram illustrating additional aspects of configurable compliance-based rewards for veterinarian clinics according to embodiments of the present invention. In the example of FIG. 2, a performance application (101) presents to a user of a veterinarian clinic (102) a compliance administration wizard (106) displayed on a veterinarian computer (111). As mentioned above, a performance application (101) is module of automated computing machinery that may be hardware, software, a combination or both, or some other form of computer logic as will occur to those of skill in the art.

In the example of FIG. 2, the performance application (101) is implemented as a module of software in random access memory (‘RAM’) (188) of the veterinarian computer (104). The callout (270) illustrates that a simplified depiction of the infrastructure of the veterinarian computer (104) for the execution of the performance application (101) provides at least a communications adapter (186), an input/output module (180), and processor (182) all coupled to the RAM through a bus (184).

Coupled for data communications with the veterinarian computer (104) and therefore the performance application (101) is a compliance-based rewards server (134). The callout (290) illustrates that a simplified depiction of the infrastructure of the server also provides at least a communications adapter (196), an input/output module (190), and processor (192) all coupled to the RAM through a bus (194). Executing in RAM in the example of FIG. 2 is a compliance engine (214). The compliance engine (214) is a module of automated computing machinery configured to generate a configurable compliance schedule for providing rewards to pet owners. As mentioned above, a configurable compliance schedule according to embodiments of the present invention is an implementation of a rewards program for a veterinarian clinic, for a pet owner, and in some cases for a particular period of time. Such a schedule defines points to receive rewards, the rewards themselves, or other benefits in dependence upon particular owner activity in compliance with the defined protocol of the veterinarian clinic. To generate such a schedule, the compliance engine maintains the criteria and attributes for those criteria received from the veterinarian clinic and applies a weighted and multidimensional algorithm using those criteria and attributes.

The compliance engine (214) in some embodiments of the present invention is dynamic. That is, the compliance schedules generated by the engine may change and so may the algorithms upon which those schedules are generated. For example, economic conditions may reduce the number of points assigned for a particular activity of a pet owner, holidays may increase the number of points assigned for a particular activity of a pet owner, periodic veterinarian specials may change the number of points or rewards provided against the schedule, and many others as will occur to those of skill in the art.

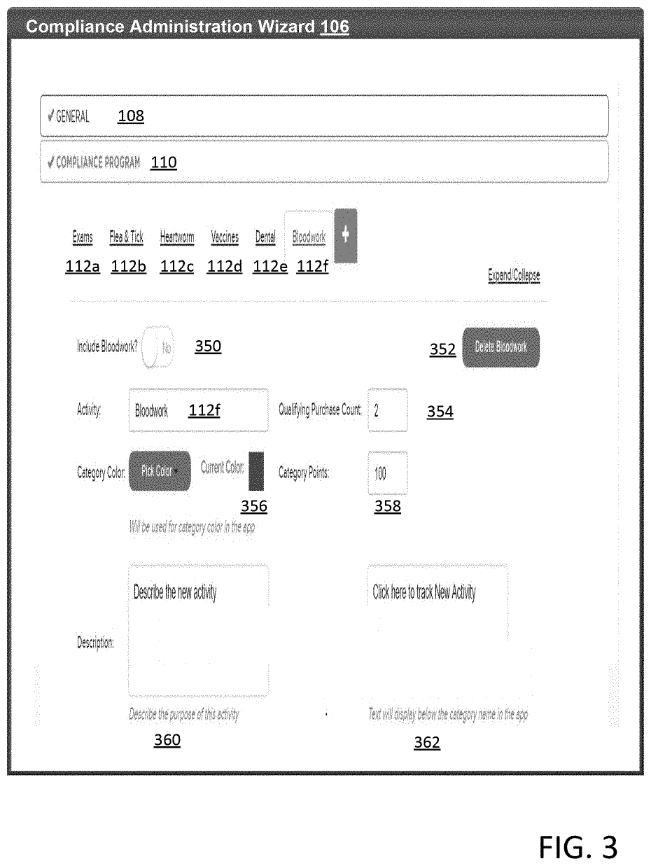

For further explanation, FIG. 3 sets forth a line drawing of an example compliance administration wizard (106) according to embodiments of the present invention. As mentioned above, the compliance administration wizard (106) of FIG. 3 provides a GUI displaying to and accepting from a user in the veterinarian clinic a selection of one or more criteria for which compliance-based rewards may be granted to a pet owner and one or more attributes defining those compliance-based rewards for that criteria.

In the example of FIG. 3, compliance administration wizard (106) includes GUI widgets to accept a compliance plan type (108) for the veterinarian clinic and program ID (110). In some embodiments, such widgets may be implanted as widgets to receive values such as alphanumeric values, pull down menus, and others as will occur those of skill in the art. In some embodiments, additional widgets may include a veterinarian ID and others as will occur to those of skill in the art.

In the example of FIG. 3, compliance administration wizard (106) includes separate screens for accepting attributes for various criteria for generating a compliance schedule. The example criteria of FIG. 3, each of which the wizard provides a screen, for criteria that include the categories of wellness exams (112a), flea and tick prevention (112b), heartworm prevention (112c), vaccines (112d), dental (112e) and bloodwork (112f). The criteria of the example of FIG. 3 are for explanation and not for limitation. In fact, many other criteria may be useful in configurable compliance-based rewards according to embodiments of the present invention as will occur to those of skill in the art.

In additional embodiments of the present invention, configurable criteria may be suggested to a user. In still other embodiments of the present invention, criteria may be completely customizable for the veterinarian clinic. That is, criterion may be established for a clinic that is completely unique to that clinic.

In the example of FIG. 3, the selection screen for the criteria bloodwork (112f) is currently being displayed by the compliance administration wizard (106). The wizard provides a widget (350) for including bloodwork as a criterion in the compliance program associated with the veterinarian clinic. The example wizard of FIG. 3 also includes a widget (352) for deleting this criterion.

In the example of FIG. 3, the selection screen for the criterion bloodwork (112f) displays an activity for this criteria (112f) provides a widget (354) to receive an assignment of a number of times such an activity should be performed in a year to comply with this criterion.

In the example of FIG. 3, the selection screen for bloodwork (112f) provides a widget (356) allowing the assignment of a category color for the criterion (112f) and provides a widget (354) to receive an assignment of a number of reward points that should be provided to the pet owner that is in compliance with this criterion.

In the example of FIG. 3, the selection screen for bloodwork (112f) includes two widgets, a first widget (360) to receive a description of the purpose of the activity and the second widget (362) to receive text describing the activity that will be provided to the user.

The example FIG. 3 is for explanation and not for limitation. As mentioned above, criteria and attributes according to the present invention are many-to-many and both criteria and attributes may be multidimensional. As such, many questions may be provided to the veterinarian for many criteria and many different attributes may describe such criteria allowing create flexibility in configurable compliance-based rewards for veterinarian clinics according to embodiments of the present invention.

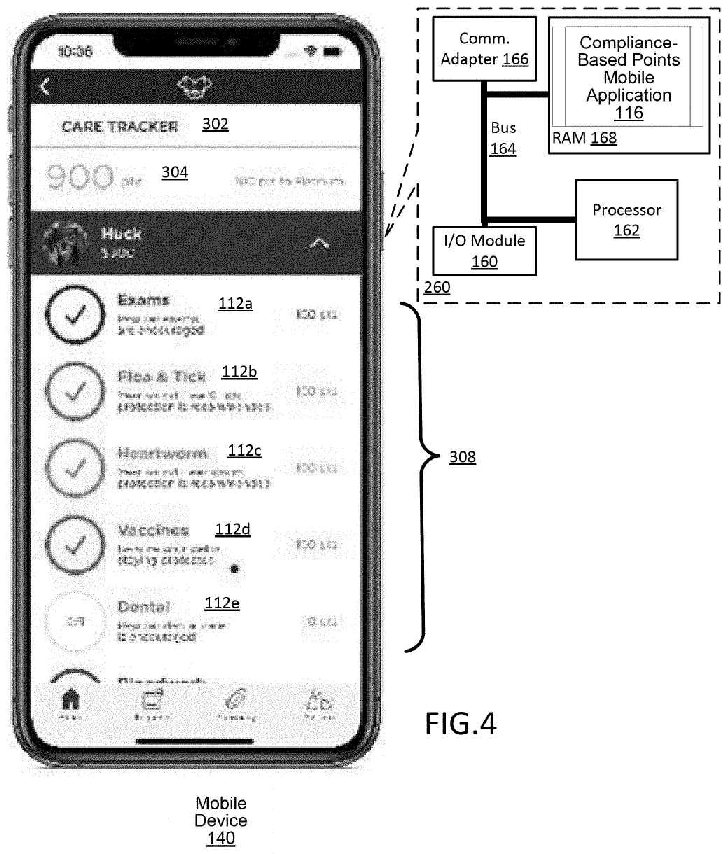

For further explanation, FIG. 4 sets forth a line drawing illustrating an example compliance-based points mobile application (116) executing on a mobile device (140). Mobile devices are computers. The callout (260) of FIG. 4 illustrates a simplified depiction of the infrastructure of the mobile device (140) that provides at least a communications adapter (166), an input/output module (160), and processor (162) all coupled to the RAM through a bus (164).

Executing in RAM in the example of FIG. 4 is a compliance-based points mobile application (116). In the example of FIG. 4, the compliance-based points mobile application (116) displays a care tracker (302) that provides the pet owner with the total number of program points (304) earned by pet owner. The compliance-based points mobile application (116) displays a series of points (308) earned for each criterion (112a-112e) associated with the configurable compliance schedule for that pet owner and the associated veterinarian clinic.

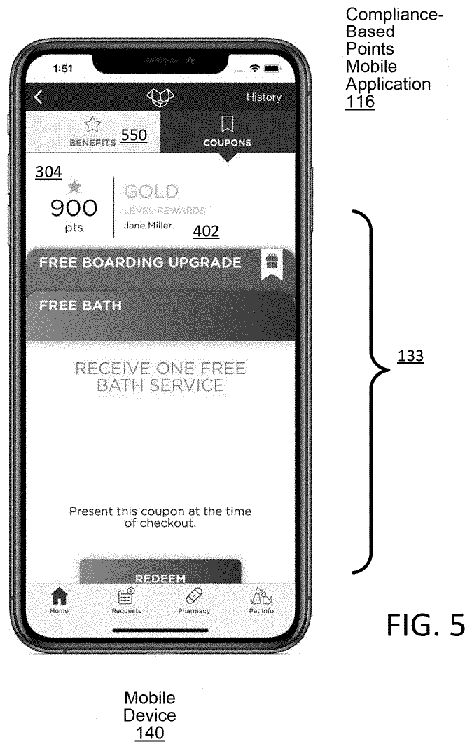

For further explanation, FIG. 5 sets forth another line drawing illustrating an example compliance-based points mobile application (116) executing on a mobile device (140). In the example of FIG. 5, the compliance-based points mobile application (116) displays to the pet owner the total number of points (304) and the current status (402) of the pet owner. The example compliance-based points mobile application (116) also displays currently earned rewards available to the pet owner and provides a selectable widget to display a selection screen describing the earned rewards. The example compliance-based points mobile application (116) also includes a selection screen (550) for benefits that when invoked describes the benefits associated with the status of the pet owner and a selection screen (552) for coupons that when invoked describes coupons available to the pet owner. In the example of FIG. 5, the coupons selection screen has been invoked and two coupons (133) are displayed, one coupon for a free boarding upgrade and the other for a free bath.

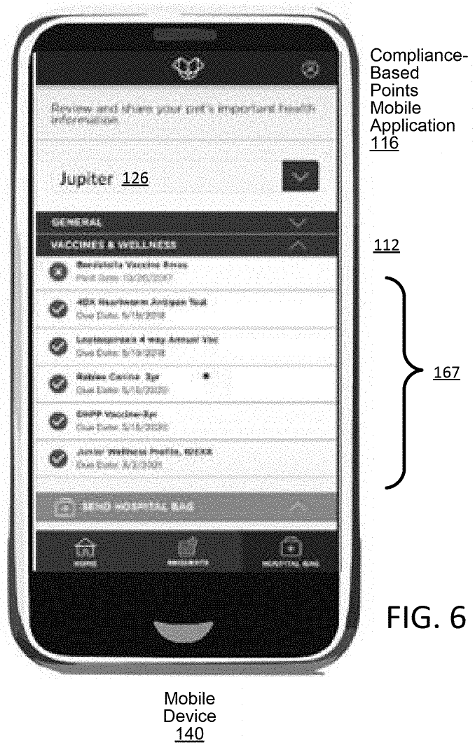

For further explanation, FIG. 6 sets forth another line drawing illustrating an example compliance-based points mobile application (116) executing on a mobile device (140). In the example of FIG. 6, the compliance-based points mobile application (116) displays a set of criteria (112) for a particular pet (126) in this example named Jupiter. The example compliance-based points mobile application (116) also displays the pet owner activity (167) and also graphically displays whether that activity or lack of activity is in compliance. For example, an icon with a check mark indicates pet owner activity that in compliance and an icon with an ‘X’ is used to depict activity or inactivity of the pet owner that is not in compliance.

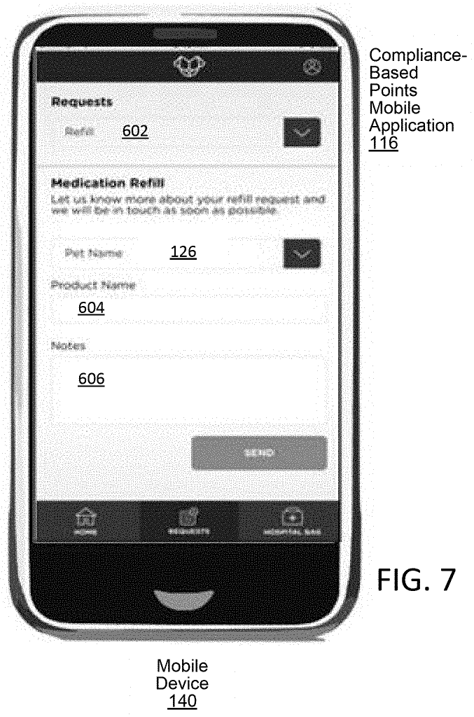

For further explanation, FIG. 7 sets forth another line drawing illustrating an example compliance-based points mobile application (116) executing on a mobile device (140). The example compliance-based points mobile application (116) of FIG. 7 displays a page allowing a pet owner to request a refill (602) through the application. The compliance-based points mobile application (116) provides a screen capable of receiving the pet name (126), the name (604) of the medication and any notes (606) to the veterinarian or clinic regarding the medication. Such a screen may be provided in response to a user selecting an alert notifying the pet owner that the refill is available. The example of FIG. 7 is for explanation and not for limitation. In fact, many products and services may be provided to a pet owner through the compliance-based points mobile application (116) such product sales, scheduling, advertisement, and many others as will occur to those of skill in the art.

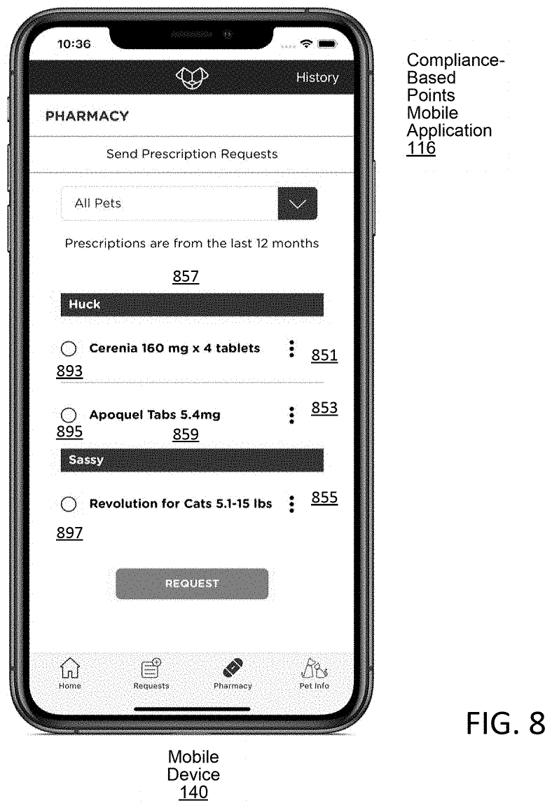

For further explanation, FIG. 8 sets forth another line drawing illustrating an example compliance-based points mobile application (116) executing on a mobile device (140). The example compliance-based points mobile application (116) of FIG. 8 displays an interface allowing a pet owner to administer pharmacy requests prescribed by the veterinarian clinic for which compliance-based rewards are provided. In the example of FIG. 8, the compliance-based points mobile application (116) provides a display of prescriptions (851, 853, and 855) for two pets, named in this example, Huck (857) and Sassy (859). The interface provided by the compliance-based points mobile application (116) allows a pet owner to request compliant pharmaceutical products for the pet owner by simply invoking one or more aspects of the GUI interface (893, 895, and 897).

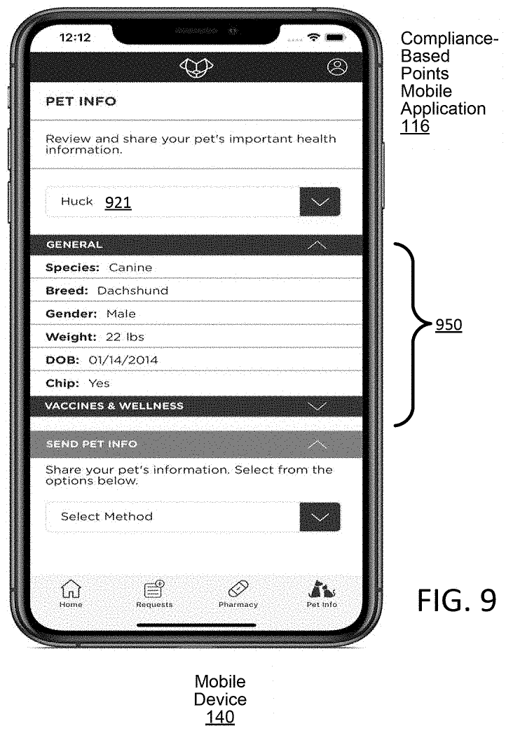

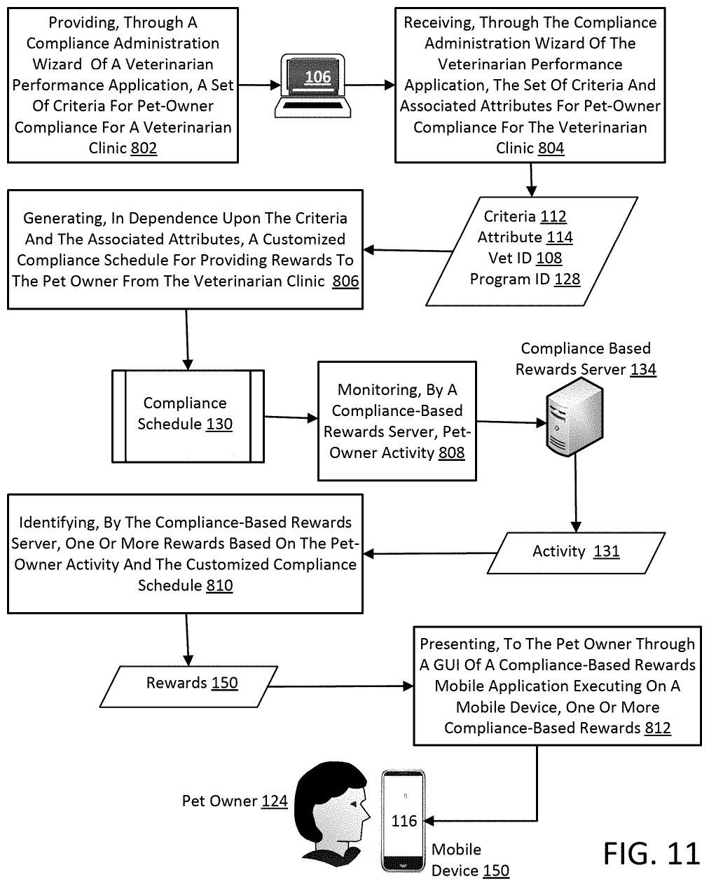

For further explanation, FIG. 9 sets forth another line drawing illustrating an example compliance-based points mobile application (116) executing on a mobile device (140). In the example of FIG. 9, the compliance-based points mobile application (116) provides an interface to administer information by the pet owner for the benefit of the veterinarian clinic. In the example of FIG. 9, the compliance-based points mobile application (116) provides an interface to select a particular pet which in this example is Huck (921). The compliance-based points mobile application (116) of FIG. 9 also provides a series of GUI interface elements (950) describing the pet including species, breed, gender, weight, date of birth, identification of whether the pet has been chipped. These elements describing aspects of the pet are for example and not for limitation. In fact, compliance-based points mobile applications (116) may include different and other aspects of the pet as will occur to those of skill in the art.

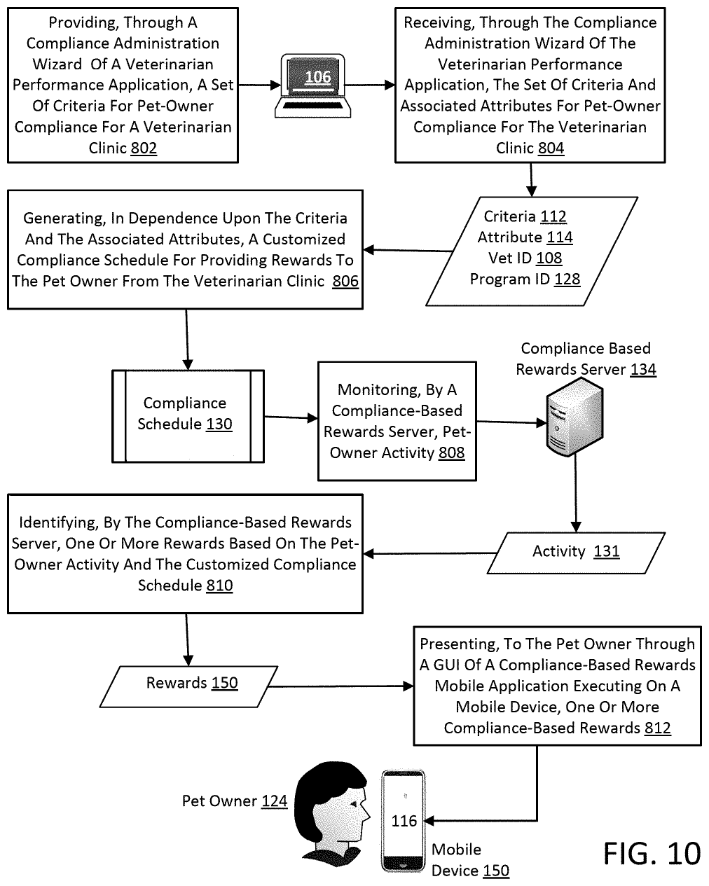

For further explanation, FIG. 10 sets forth a data flow diagram illustrating an example method for configurable compliance-based rewards for veterinarian clinics (102) according to embodiments of the present invention. The method of FIG. 10 includes providing (802), through a compliance administration wizard (106) of an application, a set of criteria (112) for pet-owner compliance for a veterinarian clinic. As discussed above, the example compliance administration wizard (106) of FIG. 10 provides a graphical user interface (‘GUI’) displaying to and accepting from a user in the veterinarian clinic (102) a selection of one or more criteria (112) for which compliance-based rewards may be granted to a pet owner (124) and one or more attributes (114) defining those compliance-based rewards for that criteria.

The method of FIG. 10 also includes receiving (804), through the compliance administration wizard (106) of the application, the set of criteria (112) and associated attributes (114) for pet-owner compliance for the veterinarian clinic (108). As discussed above, criteria (112) for which compliance-based rewards may be granted to a pet owner are one or more categories or generalized portions of a protocol for the veterinarian clinic and attributes are one or more values or sets of values defining the performance requirements of the pet owner for one or more particular criteria. Receiving (804), through the compliance administration wizard (106) of the application, the set of criteria (112) and associated attributes (114) for pet-owner compliance for the veterinarian clinic (108) may be carried out by accepting through an icon, widget, pull-down menu or other GUI function a selection of one or more criteria and one or more associated attributes.

The method of FIG. 10 also includes generating (806), in dependence upon the criteria (112) and the associated attributes (114), a configurable compliance schedule (130) for providing rewards (150) to the pet owner (124) from the veterinarian clinic. In the method of FIG. 10, generating (806), in dependence upon the criteria (112) and the associated attributes (114), a configurable compliance schedule (130) for providing rewards (133) to the pet owner (124) from the veterinarian clinic may be carried out by a performance application of the veterinarian clinic.

In an alternative embodiment, generating (806), in dependence upon the criteria (112) and the associated attributes (114), a configurable compliance schedule (130) for providing rewards (133) to the pet owner (124) from the veterinarian clinic (102) according to the method of FIG. 10 may also be carried out by transmitting the criteria (112) and associated attributes (114) to a compliance-based rewards server (134) and generating, by the compliance-based rewards server in dependence upon the criteria (112) and the associated attributes (114), the configurable compliance schedule (130) for providing rewards (133) to the pet owner (124) from the veterinarian clinic (102).

The method of FIG. 10 also includes monitoring (808), by a compliance-based rewards server (134), pet-owner activity (131). Monitoring (808), by a compliance-based rewards server (134), pet-owner activity (131) according to the method of FIG. 10 may be carried out by obtaining a practice management software server (135) associated with the veterinarian clinic (102).

The method of FIG. 10 also includes identifying (810), by the compliance-based rewards server (134), one or more rewards (150) based on the pet-owner activity (131) and the configurable compliance schedule (130). Identifying (810), by the compliance-based rewards server (134), one or more rewards (133) based on the pet-owner activity (131) and the configurable compliance schedule (130) according to the method of FIG. 10 may be carried out by assigning points for the pet-owner for one or more individual acts included in the pet-owner activity (131); maintaining a total number of points for pet owner; and comparing the total number of points with point values for available rewards.

In the example of FIG. 10 identifying (810), by the compliance-based rewards server (134), one or more rewards (150) based on the pet-owner activity (131) and the configurable compliance schedule (130) may also include assigning a status to the pet owner in dependence upon the total number of points for the pet owner.

The method of FIG. 10 also includes presenting (812), to the pet owner (124) through a GUI of a compliance-based rewards mobile application (116) executing on a mobile device (140), one or more compliance-based rewards (150). Presenting (812), to the pet owner (124) through a GUI of a compliance-based rewards mobile application (116) executing on a mobile device (140), one or more compliance-based rewards (150) according to the method of FIG. 10 may also include providing a digital redeemable reward through the compliance-based rewards mobile application (116).

In addition to presenting (812), to the pet owner (124) through a GUI of a compliance-based rewards mobile application (116) executing on a mobile device (140), one or more compliance-based rewards (150) according to the method of FIG. 10 the compliance-based rewards mobile application (116) may provide to the pet owner one or more alerts through the compliance-based rewards mobile application (116) or provide one or more product or service offerings.

Modifications, additions, or omissions may be made to the various embodiments described herein without departing from the scope of the disclosure. For example, the components of the systems and apparatuses may be integrated or separated. Moreover, the operations of the various embodiments disclosed herein may be performed by more, fewer, or other components and the methods described may include more, fewer, or other steps. Additionally, steps may be performed in any suitable order.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A method for configurable compliance-based rewards for veterinarian clinics, the method comprising:
providing, through a compliance administration wizard of an application, a set of criteria for pet-owner compliance for a veterinarian clinic;
wherein the compliance administration wizard provides a graphical user interface (‘GUI’) displaying to and accepting from a user in the veterinarian clinic a selection of one or more criteria for which compliance-based rewards may be granted to a pet owner and one or more attributes defining those compliance-based rewards for that criteria;
receiving, through the compliance administration wizard of the application, the set of criteria and associated attributes for pet-owner compliance for the veterinarian clinic; and
generating, in dependence upon the criteria and the associated attributes, a configurable compliance schedule for providing rewards to the pet owner from the veterinarian clinic;
monitoring, by a compliance-based rewards server, pet-owner activity;
identifying, by the compliance-based rewards server, one or more rewards based on the pet-owner activity and the configurable compliance schedule, as well as progress towards said rewards; and
presenting, to the pet owner through a GUI of a compliance-based rewards mobile application executing on a mobile device, one or more compliance-based rewards.

2. The method of claim 1 wherein generating, in dependence upon the criteria and the associated attributes, a configurable compliance schedule for providing rewards, as well as progress towards said rewards, to the pet owner from the veterinarian clinic is carried out by the application presented to the veterinarian clinic.

3. The method of claim 1 wherein generating, in dependence upon the criteria and the associated attributes, a configurable compliance schedule for providing rewards and progress to the pet owner from the veterinarian clinic includes:
transmitting the criteria and associated attributes to a compliance-based rewards server;
generating, by the compliance-based rewards server in dependence upon the criteria and the associated attributes, the configurable compliance schedule for providing rewards to the pet owner from the veterinarian clinic.

4. The method of claim 1 wherein monitoring, by a compliance-based rewards server, pet-owner activity further comprises obtaining a practice management software server associated with the veterinarian clinic.

5. The method of claim 1 wherein identifying, by the compliance-based rewards server, one or more rewards based on the pet-owner activity and the configurable compliance schedule further comprises:
assigning points for the pet-owner for one or more individual acts included in the pet-owner activity;
maintaining a total number of points for pet owner; and
comparing the total number of points with point values for available rewards.

6. The method of claim 1 wherein identifying, by the compliance-based rewards server, one or more rewards based on the pet-owner activity and the configurable compliance schedule further comprises assigning a status to the pet owner in dependence upon the total number of points for the pet owner.

7. The method of claim 1 wherein presenting, to the pet owner through a GUI of a compliance-based rewards mobile application executing on a mobile device, one or more compliance-based rewards further comprises providing a digital redeemable reward through the compliance-based rewards mobile application.

8. The method of claim 1 further comprising providing to the pet owner one or more alerts through the compliance-based rewards mobile application.

9. The method of claim 1 further comprising providing to the pet owner one or more products or services through the compliance-based rewards mobile application.

10. A system for configurable compliance-based rewards for veterinarian clinics, the comprising:
a compliance-based rewards server coupled for data communications with an application for a veterinarian clinic, a compliance-based points mobile application executing on a mobile device; and wherein the compliance-based rewards server is also coupled for data communications with a practice management software server associated with the veterinarian clinic;
the compliance-based rewards server configured to receive a selection of one or more criteria for which compliance-based rewards may be granted to a pet owner by the veterinarian clinic and one or more attributes defining those compliance-based rewards for that criteria;
wherein the selection of one or more criteria for which compliance-based rewards may be granted to a pet owner and one or more attributes defining those compliance-based rewards for that criteria are providing, by a user through a compliance administration wizard of an application, a set of criteria for pet-owner compliance for a veterinarian clinic;
wherein the compliance administration wizard provides a graphical user interface (GUI') displaying to and accepting from a user in the veterinarian clinic a selection of one or more criteria for which compliance-based rewards may be granted to a pet owner and one or more attributes defining those compliance-based rewards for that criteria;
the compliance-based rewards server is configured to generate, in dependence upon the criteria and the associated attributes, a configurable compliance schedule for providing rewards and progress towards rewards to the pet owner from the veterinarian clinic;
the compliance-based rewards server also is configured to monitor pet-owner activity and identify one or more rewards based on the pet-owner activity and the configurable compliance schedule; and
transmit the one or more rewards to the compliance-based rewards mobile application executing on a mobile device for presentation to the pet owner.

11. The system of claim 10 wherein the compliance-based rewards server is configured to monitor pet-owner activity by obtaining a practice management software server, or any other mechanism by which to obtain all pertinent data, associated with the veterinarian clinic.

12. The system of claim 10 wherein the compliance-based rewards server is configured to identify one or more rewards based on the pet-owner activity and the configurable compliance schedule by assigning points for the pet-owner for one or more individual acts included in the pet-owner activity; maintaining a total number of points for pet owner; and comparing the total number of points with point values for available rewards.

13. The system of claim 10 wherein the compliance-based rewards server is configured to assign a status to the pet owner in dependence upon the total number of points for the pet owner.

14. The system of claim 10 wherein the rewards further comprise a digital redeemable reward through the compliance-based rewards mobile application.

15. The system of claim 10 wherein the compliance-based rewards server is configured to provide to the pet owner one or more alerts through the compliance-based rewards mobile application.

16. The system of claim 10 wherein the compliance-based rewards server is configured to provide to the pet owner one or more products or services through the compliance-based rewards mobile application.

17. The system of claim 10 wherein the pet owner is identified and verified as having a valid email address that is associated to the veterinarian clinic to provide the pet owner with access to the application and to present all pertinent information to the pet owner as it relates to their pets within the veterinarian clinic and their progress towards rewards.
